(19) United States
(12) Patent Application Publication
(10) Pub. No.: US 2025/0225980 A1
(43) Pub. Date: Jul. 10, 2025

(54) SYSTEM AND METHOD FOR CONFIRMING APPLICATION INFORMATION

(71) Applicant: AI QA Supports Inc., Concord (CA)

(72) Inventors: Ivan NOVOSIOLOV, Ontario (CA); Andrii ZUBKO, Alicante (ES); Alexandr DUDAREV, Sunny Isles Beach, FL (US); Michael TULMAN, Sunny Isles Beach, FL (US)

(21) Appl. No.: 19/016,494

(22) Filed: Jan. 10, 2025

Related U.S. Application Data
(60) Provisional application No. 63/619,668, filed on Jan. 10, 2024.

(51) Int. Cl. G10L 15/18; G06Q 40/08; G10L 15/22; G10L 25/57; H04L 65/1096; H04M 3/42

(52) U.S. Cl. CPC G10L 15/1815; G10L 15/22; G10L 25/57; H04L 65/1096; H04M 3/42221; G06Q 40/08

(57) ABSTRACT

The present invention provides a system and method for confirming language in a form or application based on recorded conversation information between a customer and an operator or agent. In embodiments, recorded conversation information may be audio information, video information, or both and transcription information may be provided based on any of the above, and is analyzed with completed application information using a machine learning algorithm to confirm that all necessary language was provided to the customer and that all necessary response information was properly entered by the operator or agent.

### CROSS-REFERENCE TO RELATED APPLICATIONS

The present application claims benefit of and priority to U.S. Provisional Patent Application Ser. No. 63/619,668 filed Jan. 10, 2024 entitled SYSTEM, METHOD, SOFTWARE AND PROGRAMMED PRODUCTS FOR AUTOMATED RECORDED INTERACTION VERIFICATION, the entire content of which is hereby incorporated by reference herein.

### BACKGROUND

### Field of the Disclosure

The present invention generally relates to a system and method of confirming information provided during a conversation. In particular, the system and method utilize machine learning to confirm that information provided during a conversation is accurate and sufficient to complete an application or other form. The machine learning is based on a training set that includes tagged text from conversation information from prior conversations.

### Related Art

Conventionally, applications and other forms may be filled out based on conversations that employees, advisors, operators or agents have with customers or clients during telephone calls. In such situations, the employees typically follow a script and enter information manually as it is provided by the customer. While such systems are common, they are subject to human error. For example, depending on the application or form, certain disclaimers or other legal requirements may be required for disclosure to the customer. Further, in some cases, a particular answer provided by a customer may trigger a requirement for additional information and/or legal disclaimers or other legal requirements. In addition, typographical errors may result in the failure to obtain sufficient information to complete an application. In addition, in some cases, some information may simply be overlooked.

Exemplary applications or forms include insurance applications, medical forms, financial forms, loan applications, police reports, complaint forms to name a few.

Accordingly, it would be beneficial to provide a system and method that confirms information provided in an application or form.

### SUMMARY

A method for confirming information provided on an application or a form both confirms accuracy of the information provided in the form and ensures that all necessary information has been provided.

A method for confirming information in a form in accordance with an embodiment of the present disclosure includes: receiving recorded conversation information, form policy information and completed application information, wherein the recorded conversation information includes at least one of audio information and video information; generating text information associated with the recorded conversation information using a first machine learning algorithm using the recorded conversation information as an input and trained using a first training set including prior text information; receiving the text information, form policy information and completed application information as inputs to a second machine learning algorithm trained using a first training set including prior text information including tags associated with its content; outputting by the second machine learning algorithm tagged text excerpts based on the text information, completed application information and the form policy information; confirming required language in the text information and completed application information based on the text excerpts and tags; generating confirmation information associated with the text excerpts and tags confirming presence of required information in the text information and the completed application information; providing the confirmation information to an interactive user interface; and receiving input from a user via the interactive user interface associated with the confirmation information.

In embodiments, the recorded conversation information comprises audio information associated with a phone call.

In embodiments, the recorded conversation information comprises video information associated with a video call.

In embodiments, the recorded conversation information comprises audio information and video information associated with a video call.

In embodiments, the form is associated with a sale of goods.

In embodiments, the form is related to an insurance policy.

In embodiments, the recorded conversation information is provided by a third party.

In embodiments, sentiment information associated with a demeanor of a speaker is provided by the second machine learning algorithm based on audio information and video information included in the recorded conversation information.

In embodiments, the confirmation information includes the sentiment information.

In embodiments, a system for confirming content in a form in accordance with an embodiment of the present application includes: a control module implementing a platform configured to receive recorded conversation information, completed application information and form policy information; a first machine learning module operatively connected to the control module and configured to receive the recorded conversation information and provide text information associated with the recorded conversation information, wherein the text information is provided to the control module; a second machine learning module configured to implement a second machine learning algorithm, wherein the text information, completed application information and form policy information are provided as inputs to the second machine learning algorithm and the second machine learning algorithm is trained using prior text including tags related to content and provides, as an output, text excerpts from the text information and the completed application information including tags associated with contend of the transcription information and the completed application information, wherein the text excerpts and tags are processed by the control module and the control module is configured to provide confirmation information indicating presence of required text in the text information and the completed application information; and a display associated with the control unit and operably connected thereto, wherein the conformation information is displayed on the display using an interactive user interface and feedback information is provided associated with the confirmation information.

In embodiments, the recorded conversation information is provided from a third party device associated with a third party.

In embodiments, the recorded conversation information includes audio information associated with a phone call related to the completed form.

In embodiments, the recorded conversation information includes video information associated with a video phone call related to the completed form.

In embodiments, the recorded conversation information includes audio information and video information associated with a video phone call related to the completed form.

In embodiments, the recorded conversation information is associated with one of a sales call, a call between a customer and an insurance agent, and a call between a customer and a representative of a financial entity.

In embodiments, the first machine learning algorithm receives the recorded conversation information as an input and provides sentiment information indicating a demeanor of the speaker as an output with the text information.

In embodiments, the sentiment information is based on the audio information and the video information.

In embodiments, the control unit is operably connected to an external third party device and receives the recorded conversation information, completer application information and form policy information from the external third party device.

### BRIEF DESCRIPTION OF THE DRAWINGS

The above and related objects, features and advantages of the present disclosure will be more fully understood by reference to the following detailed description of the preferred, albeit illustrative, embodiments of the present invention when taken in conjunction with the accompanying figures, wherein:

FIG. 1 illustrates an exemplary flow chart of a method of confirming content in a form in accordance with an embodiment of the present disclosure;

FIG. 2 illustrates a system for confirming content in a form in accordance with an embodiment of the present disclosure;

FIG. 3 illustrates an example of a transcript that may be used in the method and system of FIGS. 1 and 2;

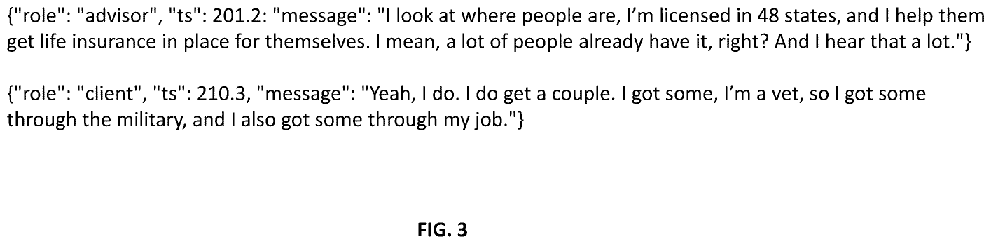

FIG. 4 illustrates an example of tagged transcript information that may be provided in the method and system of FIGS. 1 and 2;

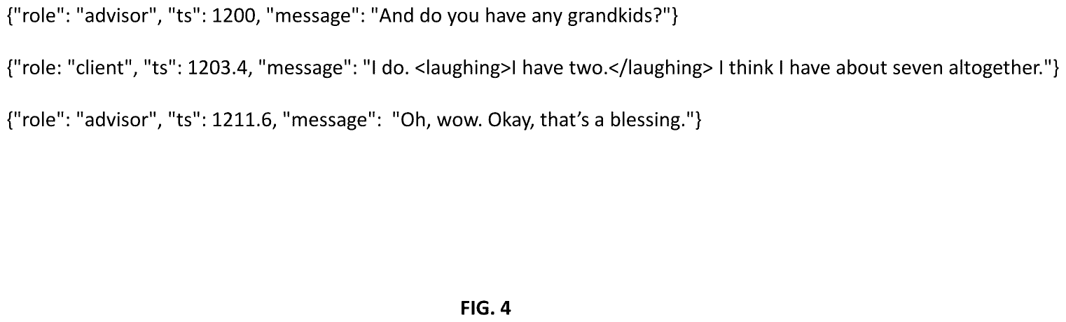

FIG. 5 illustrates a system a system for confirming content in a form in accordance with an embodiment of the present disclosure; and

FIG. 6 illustrates an exemplary flow chart of a method of confirming content in a form in accordance with an embodiment of the present disclosure.

### DETAILED DESCRIPTION

The present invention generally relates to a method and system of confirming content of an application or form based on information provided by a customer via telephone or video conference using machine learning to identify errors as well as confirming that all necessary information has been provided in the form or application. In particular, the method and system uses machine learning to analyze a transcript of a telephone conversation or recording of a video call and confirms information presented to the customer, information provided by the customer and information provided on the form and to ensure that all requirements are met.

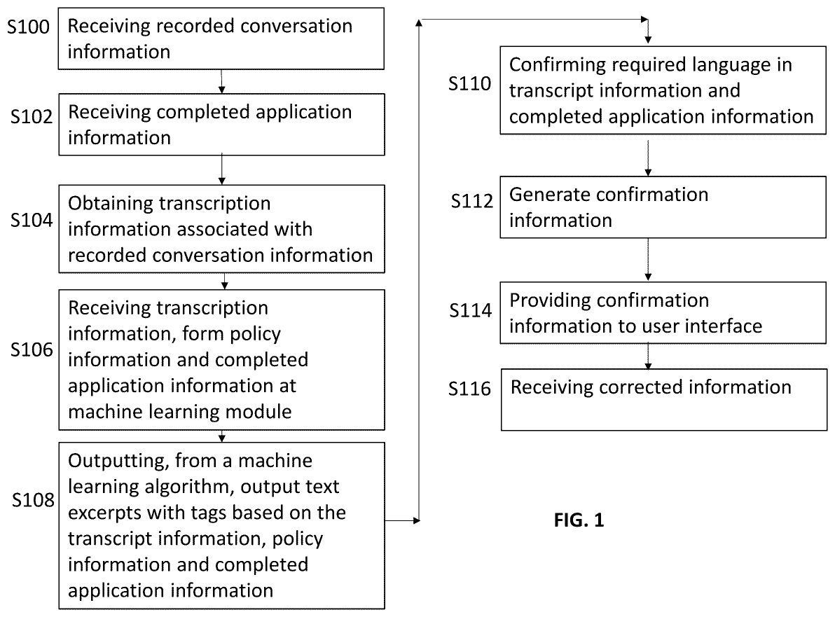

FIG. 1 illustrates an exemplary flow chart of a method of confirming information in an application or form. In embodiments, as noted above, the application may be an insurance application, loan application or bank account application, to name a few. For example, an insurance application requires certain information from the client and also requires that the insured be provided with certain information, that is required disclosures. In embodiments, the application or form may include a police report, complaint form, repair request form, to name a few.

In embodiments, as noted above, the method and system may confirm content in a form or application based on a telephone conversation, or video call or any other recorded interaction used to collect the content of the form or application. In embodiments, the application is an insurance application which requires specific information and also requires disclosure of certain information. In embodiments, in step S100, recorded conversation information may be received. In embodiments, the recorded conversation information may be a recorded telephone call. In embodiments, the recorded conversation information may be a recorded video call including video information and audio information. In embodiments, the recorded conversation information may include both audio information and video information. In embodiments, at step S102, completed application information may be received. In embodiments, the completed application information may include the questions from the application or form as well as answers to the questions provided by the client during the conversation. In embodiments, the completed application information may include form policy information associated with requirements for the application or form. As noted above, in embodiments, the application or form may be an application for insurance, a loan, or a financial account, to name a few. In embodiments, the application or form may be a police report, purchase order or customer complaint, to name a few. In embodiments, form policy information may be received in this step as well. The form policy information may indicate the requirements for the form. In embodiments, steps S100 and S102 may be combined.

In embodiments, at step S104, the recorded conversation information may by transcribed using a transcription module or other similar device or module to provide transcription information associated with the recorded conversation information. In embodiments, the transcription information may be or include text associated with the recorded conversation information. In embodiments, the transcription information may include text associated with a portion of the recorded conversation information.

In embodiments, the transcription information, form policy information and completed application information may be received by a machine learning module in step S106. In embodiments, the recorded conversation information may also be provided to the machine leaning module. In embodiments, the transcription information, form policy information and completed application information may be used as inputs for a machine learning algorithm that is trained using a training set including text tagged in accordance with content. In embodiments, the tags may correspond to predetermined statements, for example, questions in a form or application or other language in the form or application, such as regulatory or legal statements and corresponding responses. In embodiments, the tags may indicate that the transcription information matches the responses in the completed application information and complies with the requirements of the form policy information. In embodiments, training information may vary depending on the application or the form. In embodiments, the training set may be based on information provided from a third party, for example, the insurance company, financial company, etc. indicating both acceptable responses to inquiries as well as required disclosures that must be include in the conversation which may be included in the form policy information. In embodiments, in step S108, the output of the machine learning algorithm is text excerpts including associated tags.

In step S110, the output text excerpts and tags may be processed to confirm that (1) the transcript information includes all required language, including, for example, required answers and required disclosures associated with required regulatory and legal; (2) the completed application information similarly includes all required language and includes required responses and (3) whether responses in the completed application information match those provided in the transcription information. In embodiments, confirmation information may be generated and may indicate any discrepancies, including typographical or grammatical errors.

In step 112, confirmation information is generated to indicate that the tagged output text excerpts confirm that required information is present or that that there are discrepancies. In embodiments, the confirmation information may be provided to a user interface and presented to a user.

The confirmation information may be provided to the user interface in step S114. In embodiments, a user will be able to view the confirmation information which may indicate that all required statements and corresponding responses are present in both the transcription information and the completed application information and are accurate. In embodiments, where there is missing information or a discrepancy, the confirmation information may indicate the missing language and/or the discrepancy. As noted above, in embodiments, a discrepancy may be based on a typographical error.

In embodiments, the user interface may be interactive and may receive input from a user. In embodiments, the interface may be used to display the confirmation information to the user via a display element. In embodiments, the display element may be a touchscreen. In embodiments, the display element may be connected to or associated with a PC, a laptop or a portable electronic device, such as a smartphone, for example. In embodiments, one or more input devices, such as a keyboard, keypad, mouse, stylus, to name a few may be associated with the display element. In embodiments, the user may provide feedback, in the form of instructions, for example via the user interface. In embodiments, the user may simply acknowledge the confirmation that there are no issues with the transcript and the completed application in which case, the completed application may be stored in memory, and/or transferred to a third party. In embodiments, the third party may be a loan company, insurance company, financial company etc.

In embodiments, where the confirmation information indicates a discrepancy, the nature of the discrepancy may be displayed to the user. For example, where required language is not present in the transcription information, the missing language may be displayed to the user with a notification that it was not included in the transcription information, and thus, regulatory or legal requirements have not been met. The user may then decide how to address the discrepancy. In embodiments, the user may provide instructions to initiate a second conversation in which the missing language is used and second completed application information is gathered. In embodiments, the recorded second conversation information and second completed application information may be subjected to the above steps to ensure compliance and the tagged second completed application information may be saved or processed by a third party.

In embodiments, where the required language is not included in the transcription information, the transcription information and the completed application information may simply be discarded. In embodiments, the tagged text excerpts from the transcription information and the completed application information may be stored in a memory. In embodiments, the tagged text excerpts may be used to train the machine learning algorithm.

In embodiments, where the confirmation information indicates a discrepancy in a response included in the completed application information, the user may be given the opportunity to provide feedback and correct the response information in the completed application information based on the text excerpts information in step S116. In embodiments, the corrected information may be provided using the user interface by an input device associated with the display. In embodiments, the corrected completed application information may be saved and/or sent to the third party.

In embodiments, where the discrepancy is between a response in the transcription information and a response in the completed application information, the user may be given the opportunity to correct the response via the user interface and display. In embodiments, the user may be given the opportunity to listen to a corresponding portion of the recorded conversation to determine the correct response and may modify the completed application information to include the correct response.

In embodiments, the user interface may generate a log entry that indicates a correction was made to the transcription information or completed application information and may include this indication in the tagged transcript information or tagged completed application information and may be used as training information for the machine learning algorithm.

In embodiments, the log entry may include a reference to the recorded conversation information associated with the correction. In embodiments, the tagged text excerpts from the transcription information and the completed application information may be stored and added to the training information used to train the machine learning algorithm. In embodiments, the log entry may be added to the training information.

In embodiments, the conversation that is recorded may be a recorded telephone conversation as noted above. In embodiments, the recorded conversation may be a video conference including video information and audio information. In embodiments, where the recorded conversation includes both video information and audio information, in step S102, the transcription information may be provided based on the audio information. In embodiments, the transcript information in steps S102 may be based on video information. In embodiments, the transcript information may be based on both audio information and video information.

In embodiments, where the recorded conversation information includes video information and audio information, the video information and audio information may be provided to a machine learning module as an input to the machine learning algorithm. In embodiments, the machine learning algorithm may also provide, as an output, tagged video information and tagged audio information indicating a sentiment of the customer in the conversation. In embodiments, certain characteristics of the audio information may be used to determine sentiment of the user, for example, the vocabulary used, the context and/or tone of voice. In embodiments, aspects of the video information may also indicate sentiment, for example facial expressions and body language. In embodiments, such sentiment information may be used to identify deception on the part of a speaker which may be used to identify discrepancies. In embodiments the machine learning algorithm may be implemented by the transcription machine learning module 116 or any other suitable device or module.

In embodiments, the confirmation information may be generated based on the sentiment information as well. In embodiments, the confirmation information may also include a suggestion to accept or reject the completed application information. In embodiments, the suggestion to reject may be based on discrepancies as generally discussed above. In embodiments, the suggestion to reject the application information may be based on the sentiment information, which may, for example, indicate deception in responses.

In embodiments, the machine learning algorithm may provide tagged transcript information and tagged completed application information including tags associated with grammatical errors. In embodiments, the grammatical errors may be considered discrepancies that may be used by the user to reject the completed application information or that may be corrected, as discussed above.

In embodiments, the recorded conversation may be a sales call and the completed application may be or include a sales slip or sales form documenting a sale. In embodiments, as generally discussed above, the recorded conversation may be associated with a consultation regarding insurance, an investment, a mortgage or a legal matter, including a police interview or report.

In embodiments, the machine learning algorithm may be or may utilize a multimodal large language model (LLM). In embodiments, the machine learning algorithm may be or may utilize a convolutional neural network.

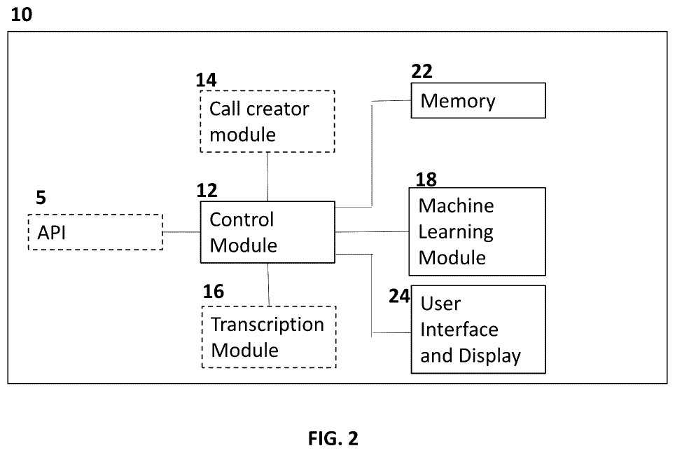

FIG. 2 illustrates an exemplary system 10 that may be used to confirm content of a conversation and a form and may be used to implement the method of FIG. 1. In embodiments, the system 10 may utilize an API to receive information in a suitable format for further processing, however, the API may not be used. In embodiments, users of the system 10 access the system via credentials. In embodiments, a control module 14 may receive the recorded conversation information as in step S100 of FIG. 1. In embodiments, the recorded conversation information may be imported or uploaded from an external source, such as an insurance company computer system, financial company computer system, etc., via the API 5. In embodiments, the recorded conversation information may be provided from an agent or operator view the call creator module 14, which may be included in the system 10. In embodiments, the application information may be provided via the API 5, for an external source or from the agent or operator using the call creator module 14. In embodiments, a conversation recording element 16 may be included in the system 10 to provide the recorded conversation.

In embodiments, the call creator module 14 may be part of the system 10. In embodiments, the call creator module 14 may be used by an operator or agent to call a customer and may record the conversation to provide the recorded conversation information. The completed application information may also be provided using input provided by the operator or agent during the conversation. In embodiments, the call creator moule 14 may include an input, such as a keyboard, touchscreen, mouse or the like configured to allow the operator or agent to enter information to the completed application information provided by the user during the telephone conversation. In embodiments, application information may be provided by the customer verbally and entered by the agent or operator. The application information may be provided from the operator or agent via the call creator module 14 as noted above. In embodiments, the recorded conversation information may be provided to the control module 12, for example, in step 100. In embodiments, the application information may be provided from the exterior via the API 5 or from the agent or operator via the call creator module 14 in step 102, for example. In embodiments, the call creator module 14 may not be included in the system 10 at all and the recorded conversation information may be provided from outside system 10 via the API or any other suitable interface.

In embodiments, the control module 12 may provide the recorded conversation information to a transcription module 16 which may be used to generate transcript information associated with the recorded conversation as in step S104. In embodiments, the transcription module 16 may be provided in the system 10 or may be provided outside of the system and operably connected thereto to provide the transcript information. In embodiments, the transcription module 16 may be implemented using machine learning. In embodiments, the transcript information may be stored in memory 22 operably connected to the control module 12. In embodiments, the control module 12 may be implemented by one or more processor operably connected to memory including processor executable instructions to perform the steps herein.

In embodiments, the transcript information and completed application information may be provided to machine learning module 18. In embodiments, the machine learning module 18 may uses a machine learning algorithm trained by tagged text excerpts from prior transcript information and completed application information to provide text excerpts, as in step S108, including tags associated with content of the transcript information and completed application information, which are provided as inputs to the machine learning algorithm. In embodiments, the recorded conversation information may be provided as an input to the machine learning algorithm and the text excerpts may include tags associating the text excerpt with associated portions of the recorded conversation information.

In embodiments, the tagged text excerpts may be processed by the control module 12 to confirm that required information is included in the transcript information and the completed application information, as in step S110. In embodiments, the control module 12 may determine that all required information is included in the transcript information and the completed application information. In embodiments, the confirmation information may be generated to indicate that the tagged text excerpts confirm that required information is present as in step S112. In embodiments, the confirmation information may indicate that there are discrepancies between the transcript information and completed application information. In embodiments, the confirmation information may be provided to a user interface which may be used to display the confirmation information on a display 24 such that it is visible to a user, for example at step S114. As noted above, the confirmation information may be displayed to the user using via a monitor associated with the using the user interface.

The confirmation information may be provided to the user interface in step S114. In embodiments, a user will be able to view the confirmation information on display 24 which may indicate that all required statements and corresponding responses are present in both the transcript information and the completed application information. In embodiments, where there is missing information or a discrepancy between the transcript information and the complete application information, the confirmation information may indicate the missing language and/or the discrepancy. As noted above, in embodiments, a discrepancy may be based on a typographical error.

In embodiments, the user interface may be interactive and may receive feedback input from a user via the display 24 or another input associated thereto. In embodiments, the display 24 may be a touchscreen. In embodiments, the display 24 may be connected to or associated with a PC, a laptop or a portable electronic device, such as a smartphone, for example. In embodiments, one or more input devices, such as a keyboard, keypad, mouse, stylus, to name a few may be associated with the display 24. In embodiments, the user may provide instruction information via the user interface using the display 24. In embodiments, the user may simply acknowledge that there are no issues with the transcript information and the completed application information in which case, the completed application information may be stored in memory, and/or transferred to a third party for processing. In embodiments, the third party may be a customer such as a loan company, insurance company, financial company etc.

In embodiments, where the confirmation information indicates a discrepancy, the nature of the discrepancy may be displayed to the user. For example, where required language has not been provided in the transcript information or the completed application information, the missing language may be displayed to the user with a notification that it was not included in the transcript or the completed application information or both, and thus, regulatory or legal requirements have not been met. The user may then decide how to address the discrepancy. In embodiments, the user may provide instructions to initiate a second conversation in which the missing language is used and second completed application information is gathered. In embodiments, the recorded second conversation information and second completed application information may be subjected to the above steps to provided second tagged text excerpts and second confirmation information. Where the second confirmation indicates that the required information is provided in the second transcript information and the second completed application information, the second transcript information and the second completed application may be saved, for example, in memory 22 and/or processed by a third party.

In embodiments, where the required language is not included in the transcript information or completed application information, the transcript information and the completed application information may simply be discarded. In embodiments, the tagged text excerpts may be stored in memory 22. In embodiments, the tagged text excerpts may be used to train the machine learning algorithm.

In embodiments, where the confirmation information indicates a discrepancy in a response included in the completed application information, the user may be given the opportunity to correct the response information in the completed application information based on the transcript information as in step S116. In embodiments, the corrected information may be provided using the user interface by an input device associated with the display 24. In embodiments, the corrected completed application information may be saved and/or sent to the third party.

In embodiments, where the discrepancy is between a response in the transcript information and a response in the completed application information, the user may be given the opportunity to correct the response via the user interface and display 24. In embodiments, the user may be given the opportunity to listen to a corresponding portion of the recorded conversation to determine the correct response and may modify the completed application information to include the correct response.

In embodiments, the user interface may generate a log entry that indicates a correction was made to the transcript information or completed application information and may include this indication in the tagged text excerpts or conformation information and may be used as training information for the machine learning algorithm. In embodiments, the log entry may include a reference to the recorded conversation information associated with the correction. In embodiments, the log entry may be added to the training information.

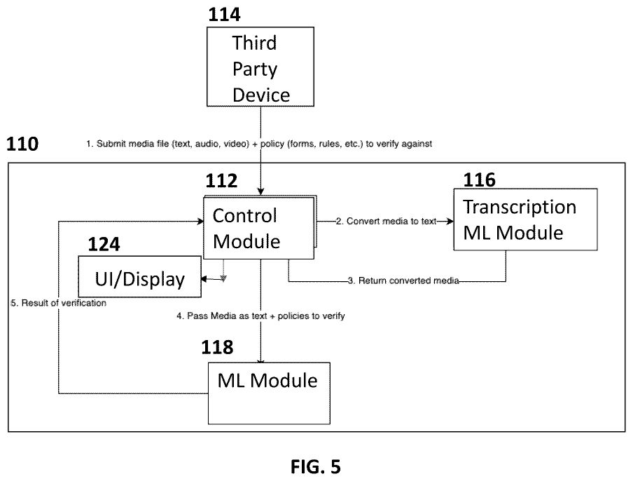

FIG. 5 illustrates an embodiment of a system 110 that may be used to authenticate a recorded conversation and form information provided during the conversation in accordance with an embodiment of the present disclosure. In embodiments, the form referred to may be the application discussed above. That is, form and application are used interchangeably. In embodiments, as indicated in FIG. 5, the recorded conversation information may be provided from a third party device 114, for example, an insurance company computer system, financial company computer system, etc. As noted above, an API may be used to receive such information, however, may not be used or necessary. In embodiments, the third party may be a customer. In embodiments, the third party device 114 may provide credentials, make a payment or provide biometric information to access the system 110. In embodiments, the third party device 114 may also provide form policy information indicating the required information that must be included in the application information when it is provided as well as any required disclosure information associated with the form that must be presented during the conversation.

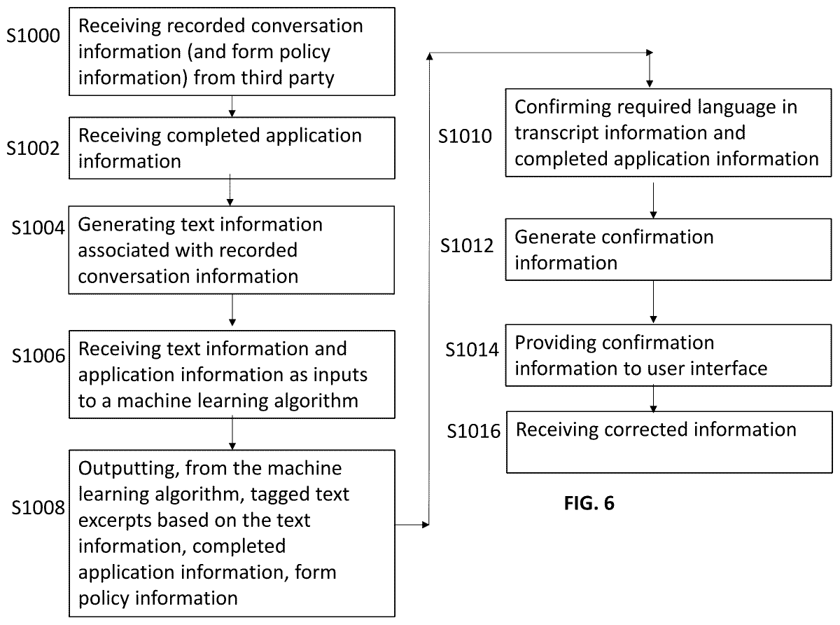

In embodiments, as noted above, the recorded conversation information may be a recorded telephone conversation, a recorded video conversation or any other recorded conversation medium. The third party device 114 may provide the recorded conversation information in the form of a computer file which may be an audio file, video file or audio/video file. FIG. 6 illustrates an exemplary flow chart of a method to authenticate a recorded conversation and form information provided during the conversation using the system 110 discussed above. In step 1000, the recorded conversation information may be received from a third party, for example from third party device 114 associated with the third party. In embodiments, the form policy information may be received with the recorded conversation information. In embodiments, the form policy information may indicate which responses are necessary in a form as well as required disclosure information that should be presented in the recorded conversation information. In embodiments, the form policy information may be received separately from the recorded conversation information. In embodiments, completed application information that has been provided during the conversation may be received in step S1002. The completed application information may include all questions or prompts for information on the form as well as the answers or information provided during the conversation. The term completed application information refers to both completed applications and completed forms. In embodiments, all of the recorded conversation information, form policy information and completed application information may be received in a single step. As noted above, prior to receiving this information, the third party device 114 may provide credentials, payment information or biometric information to confirm that third party is customer or otherwise has a relationship with the system 110.

In embodiments, the recorded conversation information, which may include audio information, video information or both, is transcribed in step S1004 to provide text information associated with a text transcription of the recorded conversation information. The text information is similar to the transcription information discussed above. In embodiments, the text information may be provided by using a transcription machine learning module 116 in which the audio information, video information or both may be provided as inputs in a first machine learning algorithm that may be trained using prior audio or visual information and text to provide text information including the text of the recorded conversation. In embodiments, the transcription machine learning module 116 may be implemented to provide text information using just audio information as an input, just video information as an input or both audio and video information as inputs. In embodiments, the text information includes text associated with the recorded conversation. As noted above, in embodiments, the transcription machine learning module 116 may provide tags associated with excerpts of text that may indicate a sentiment of the speaker which may be used to determine the likelihood that the speaker is being honest. In embodiments, the sentiment information may be provided based on expression of the speaker, vocabulary, tone of voice or visual indicators included in the audio information and the video information.

In embodiments, in step S1006, the text information is provided to machine learning module 118 along with the form policy information and completed application information. In embodiments, the text information, form policy information and completed application information are provided as inputs to a second machine learning algorithm implemented by the machine learning module 118 to provide tagged text excerpts indicating whether required responses and required disclosures are included in the recorded conversation information. In embodiments, the second machine learning algorithm may be trained using tagged text excerpts indicating required responses and required disclosures as noted above. In embodiments, such tagged text excerpts may be provided from prior output of the second machine learning algorithm. In embodiments, the tagged text excerpts may indicate any discrepancies in the text information including typographical or grammatical errors. In embodiments, as noted above, discrepancies may also indicate missing responses and missing required disclosures.

In step S1008, the second machine learning algorithm provides tagged text excerpts based on the transcription information, completed application information and form policy information. In embodiments, at step S1010, the tagged text excerpts are processed to determine whether all required responses and required disclosures are present in the text information and completed application information or whether there are discrepancies.

In embodiments, in step S1012, confirmation information is generated based on the processing in step S1010. In embodiments, the confirmation information indicates whether all required responses and required disclosures are present in the text information and completed application information also indicates whether there are any discrepancies in the text information. In embodiments, the confirmation information may include the tagged text excerpts provided by the second machine learning algorithm. In embodiments, the confirmation information may be provided to a user interface in step S1014. In embodiments, a user will be able to view the confirmation information which may indicate that all required statements and corresponding responses are present in both the transcription information and the completed application information based on the requirements provided in the form policy information. In embodiments, where there is missing information or a discrepancy, the confirmation information may indicate the missing language and/or the discrepancy. As noted above, in embodiments, a discrepancy may be based on a typographical error.

In embodiments, as noted above, the user interface may be interactive and may receive input from a user. In embodiments, the interface may be used to display the confirmation information to the user via a display clement 124. In embodiments, the display clement 124 may be a touchscreen. In embodiments, the display element 124 may be connected to or associated with a PC, a laptop or a portable electronic device, such as a smartphone, for example. In embodiments, one or more input devices, such as a keyboard, keypad, mouse, stylus, to name a few may be associated with the display element 124. In embodiments, the user may provide instruction information via the user interface. In embodiments, the user may simply acknowledge the confirmation that there are no issues with the transcript information and the completed application in which case, the completed application may be stored in memory, and/or transferred back to the third party for further action. In embodiments, the third party may be a loan company, insurance company, financial company etc. In embodiments, the confirmation information may be provided to the third party directly.

In embodiments, where the confirmation information indicates a discrepancy, the nature of the discrepancy may be displayed to the user as noted above. For example, where a required response or required language is not present in the transcription information, the missing language may be displayed to the user with a notification that it was not included in the transcription information, and thus, the form is incomplete or regulatory or legal requirements have not been met. The user may then decide how to address the discrepancy, which may include a follow-up conversation where the second conversation may be processed as in the above steps. In embodiments, the user may insert missing information if it can be determined based on the recorded conversation or the transcription information.

In embodiments, where the required language is not included in the text information, the text information and the completed application information may simply be discarded. In embodiments, as noted above, the tagged text excerpts from the text information and the completed application information may be stored in a memory. In embodiments, the tagged text excerpts are included in the second training set and used to train the second machine learning algorithm.

In embodiments, where the confirmation information indicates a discrepancy in a response included in the completed application information, the user may be given the opportunity to correct the response information in the completed application information based on the text excerpts information in step S1016. In embodiments, step S1016 is the corrected information may be provided using the user interface by an input device associated with the display 124. In embodiments, the corrected completed application information may be saved and/or sent to the third party device.

In embodiments, steps S1008 and S1010 may be performed using the second machine learning module 118. In embodiments, steps S1012 may be performed by the second machine learning module 118 or in the control module 112. In embodiments, the control module 112 may be implemented via a processor operably connected to memory, wherein the memory includes processor executable code, that when executed by the processor, performs the steps discussed above and may be similar to module 12 discussed above. In embodiments, the control module 112 may be used to implement an AI platform used to authenticate a recorded conversation and completed form information in accordance with the methods and systems discloses herein. In embodiments, the system 110 may include the display 124 operably connected to the control module 112, which may be operable to present the user interface discussed above. In embodiments, the control module 112 may receive the recorded conversation information, completed application information and form policy information from the third party device 114 and may provide information, such as the confirmation information, to the third party device.

In embodiments, certain characteristics of the tagged text excerpts may be used to determine sentiment of the user, for example, the vocabulary used, tone of voice or the context. As noted above, text information may also be tagged based on the corresponding video information may also be tagged as an indication of sentiment as well. In embodiments, as noted above, aspects of the video information that indicate sentiment may include facial expressions and body language.

In embodiments, as noted above, the confirmation information may be generated based on the sentiment information as well. In embodiments, the confirmation information may also include a suggestion to accept or reject the completed application information, which may be based on the tagged text excerpts as well as the sentiment information and form policy information.

In embodiments, a method for confirming information in an application includes: receiving recorded conversation information associated with the application; receiving completed application information associated with the application and form policy information; obtaining transcription information based on the recorded conversation information; receiving transcription information, form policy information and completed application information as inputs to a first machine learning algorithm trained using a training set including prior text and tags associated with its content; outputting by the machine learning algorithm text excerpts including tags associated with content of the transcription information and the completed application information; confirming required language in the transcription information and the completed application information based on the text excerpts including tags; generating confirmation information based on the text excerpts including tags to confirm presence of required information in the transcription information and the completed application information; providing the confirmation information to an interactive user interface; and receiving input from a user via the interactive user interface.

In embodiments, the recorded conversation information is associated with a sales call.

In embodiments, the recorded conversation information is associated with a call between a customer and an insurance agent.

In embodiments, the recorded conversation information is associated with a call between a customer and a representative of a financial entity.

In embodiments, the recorded conversation information is associated with a video call and includes audio information and video information.

In embodiments, the recorded conversation information includes audio information.

In embodiments, the recorded conversation information includes video information.

In embodiments, the machine learning algorithm provides, as an output, sentiment information associated with a sentiment of the customer based on the transcription information and the video information.

In embodiments, the confirmation information includes the sentiment information.

In embodiments, the recorded conversation information is provided from a third party device.

In embodiments, the step of obtaining transcription information is performed by a second machine learning algorithm.

In embodiments, the second machine learning algorithm is trained using a second training set including prior transcription information.

A system for confirming content in an application in accordance with an embodiment of the present disclosure includes: a control module configured to receive recorded conversation information and completed application information; a transcription module operatively connected to the control module and configured to receive the recorded conversation information and provide transcription information associate with the recorded conversation information, wherein the transcription information is provided to the control module; a machine learning module configured to implement a machine learning algorithm, wherein the transcription information, form policy information and the completed application information are provided as inputs to the machine learning algorithm and the machine learning algorithm is trained using prior text including tags related to content and provides, as an output, text excerpts from the transcription information and the completed application information including tags associated with contend of the transcription information and the completed application information, wherein the text excerpts and tags are processed by the control module and the control module is configured to provide confirmation information indicating presence of required text in the transcript information and completed application information; and a display associated with the control unit and operably connected thereto, wherein the conformation information is displayed on the display using an interactive user interface.

In embodiments, the system includes a call creator module configured to initiate a telephone call between a customer and an operator and provide the recorded conversation information.

In embodiments, the call creator module and the transcription module are provided exterior to the system and are operable connected to the control module.

In embodiments, the recorded conversation information is associated with one of a sales call, a call between a customer and an insurance agent, and a call between a customer and a representative of a financial entity.

In embodiments, the recorded conversation information comprises audio information.

In embodiments, the recorded conversation information comprises video information.

In embodiments, the transcription module utilizes a second machine learning algorithm that receives the recorded conversation information as an input and provides the transcription information as an output.

In embodiments, the machine learning algorithm provides, as an output, sentiment information associated with a sentiment of the customer based on the transcription information and the video information.

In embodiments, the control unit is operably connected to a third party device and receives the recorded conversation information and form policy information associated with required responses and required disclosures to be included in the recorded conversation information.

In embodiments, the display is associated with an input configured to provide corrections from a user via the user interface.

It is understood that the examples and embodiments described herein are for illustrative purposes only and that various modifications or changes in light thereof will be suggested to persons skilled in the art and are to be included within the spirit and purview of this application and scope of the appended claims. Further, it is understood that examples and embodiments described herein with reference to diagnosis do not limit the scope of the appended claims and instead are illustrative of examples and embodiments.

Now that embodiments of the present invention have been shown and described in detail, various modifications and improvements thereon can become readily apparent to those skilled in the art. Accordingly, the exemplary embodiments of the present invention, as set forth above, are intended to be illustrative, not limiting. The spirit and scope of the present invention is to be construed broadly.

What is claimed is:

1. A method for confirming information in a form comprises:
a. receiving recorded conversation information, form policy information and completed application information, wherein the recorded conversation information includes at least one of audio information and video information;
b. generating text information associated with the recorded conversation information using a first machine learning algorithm using the recorded conversation information as an input and trained using a first training set including prior text information;
c. receiving the text information, form policy information and completed application information as inputs to a second machine learning algorithm trained using a second training set including prior text information including tags associated with its content;
d. outputting by the second machine learning algorithm tagged text excerpts based on the text information, completed application information and the form policy information;
e. confirming accuracy of the text information and completed application information based on the text excerpts and tags;
f. generating confirmation information associated with the text excerpts and tags confirming presence of required information and accuracy of the text information and the completed application information;
g. providing the confirmation information to an interactive user interface; and
h. receiving input from a user via the interactive user interface associated with the confirmation information.

2. The method of claim 1, wherein the recorded conversation information comprises audio information associated with a phone call.

3. The method of claim 1, wherein the recorded conversation information comprises video information associated with a video call.

4. The method of claim 1, wherein the recorded conversation information comprises audio information and video information associated with a video call.

5. The method of claim 1, wherein the form is associated with a sale of goods.

6. The method of claim 1, wherein the form is related to an insurance policy.

7. The method of claim 1, wherein the recorded conversation information is provided by a third party.

8. The method of claim 1, wherein sentiment information associated with a demeanor of a speaker is provided by the second machine learning algorithm based on audio information and video information included in the recorded conversation information.

9. The method of claim 8, wherein the confirmation information includes the sentiment information.

10. A system for confirming content in a form comprises:
a. a control module implementing a platform configured to receive recorded conversation information, completed application information and form policy information;
b. a first machine learning module operatively connected to the control module and configured to receive the recorded conversation information and provide text information associated with the recorded conversation information, wherein the text information is provided to the control module;
c. a second machine learning module configured to implement a second machine learning algorithm, wherein the text information, completed application information and form policy information are provided as inputs to the second machine learning algorithm and the second machine learning algorithm is trained using prior text including tags related to content and provides, as an output, text excerpts from the text information and the completed application information including tags associated with contend of the transcription information and the completed application information,
wherein the text excerpts and tags are processed by the control module and the control module is configured to provide confirmation information indicating presence of required text in the text information and the completed application information; and
d. a display associated with the control unit and operably connected thereto,
wherein the conformation information is displayed on the display using an interactive user interface and feedback information is provided associated with the confirmation information.

11. The system of claim 10, wherein the recorded conversation information is provided from a third party device associated with a third party.

12. The system of claim 10, wherein the recorded conversation information includes audio information associated with a phone call related to the completed form.

13. The system of claim 10, wherein the recorded conversation information includes video information associated with a video phone call related to the completed form.

14. The system of claim 10, wherein the recorded conversation information includes audio information and video information associated with a video phone call related to the completed form.

15. The system of claim 10, wherein the recorded conversation information is associated with one of a sales call, a call between a customer and an insurance agent, and a call between a customer and a representative of a financial entity.

16. The system of claim 10, wherein the first machine learning algorithm receives the recorded conversation information as an input and provides sentiment information indicating a demeanor of the speaker as an output with the text information.

17. The system of claim 16, wherein the sentiment information is based on the audio information and the video information.

18. The system of claim 10, wherein the control unit is operably connected to an external third party device and receives the recorded conversation information, completer application information and form policy information from the external third party device.

19. The system of claim 10, wherein the display is associated with an input configured to provide the feedback information. The system of claim 10, wherein the feedback information includes correction information where the confirmation information indicates discrepancies between the text information, completed application information and form policy information.
